(19) United States
(12) Patent Application Publication
(10) Pub. No.: US 2026/0112370 A1
(43) Pub. Date: Apr. 23, 2026

(54) Handheld Device for Audio Recording, Transcription, and Playback with AI Chat Capabilities

(71) Applicant: Anthony Trizzino, Manchester, NJ (US)

(72) Inventor: Anthony Trizzino, Manchester, NJ (US)

(21) Appl. No.: 18/920,293

(22) Filed: Oct. 18, 2024

(51) Int. Cl. G10L 17/00; G10L 15/22; G10L 15/26

(52) U.S. Cl. CPC G10L 17/00; G10L 15/22; G10L 15/26

(57) ABSTRACT

The device is a handheld device designed to record audio during meetings and other verbal interactions, transcribe the content in real-time, and identify speakers based on voice input. It includes features for organizing recording data, such as naming recordings and tagging speaker identities. The device also offers an interactive playback feature, allowing users to engage with an AI system powered by OpenAI's language models to review or query past recordings. The AI can reference both recordings stored on the device and, in certain models, recordings stored via cloud-based systems. Users can ask questions to retrieve recording summaries, specific statements, or details.

### BACKGROUND OF THE INVENTION

### 1. Field of the Invention

The present invention relates to a device for recording and transcribing audio from meetings or other verbal interactions, with interactive AI-powered playback functionalities. More specifically, it focuses on using real-time transcription and speaker identification, as well as an AI chatbot for querying stored audio data.

### 2. Description of the Prior Art

Existing devices primarily offer either audio recording or transcription, but few offer real-time transcription, speaker identification, and AI-driven playback in one portable device. Current solutions typically require separate software to transcribe audio or provide AI assistance, making the process fragmented and inefficient. Many recording devices lack integrated AI chatbot features, flexible cloud-based storage, and speaker recognition capabilities. This invention bridges that gap by combining all these functionalities into a single, compact device without the need to connect to the internet.

### BRIEF SUMMARY OF THE INVENTION

To enable a person to record audio on a device without internet, transcribe it in real-time, identify speakers based on voice inputs, and use verbal commands to reference the recorded audio in the future. This is achieved by storing transcriptions in an organized manner, allowing users to name recordings and identify speakers. The device includes an AI chatbot powered by OpenAI's language models, which provides interactive playback and review of the recordings. The AI system can be updated or improved as language models evolve over time, allowing users to ask questions such as summarizing past recordings or retrieving specific statements made by speakers.

### DETAILED DESCRIPTION OF THE INVENTION

The device consists of several key components:

### Physical Design

A small touch screen (1.5″ wide×2″ high) located at the top of the device for displaying transcription progress, speaker identification, and playback options.

Below the screen is a central button surrounded by directional buttons (up, down, left, right) for navigation.

Additional buttons are placed below the central button array. For reference, we will identify two main buttons as the “red button” for recording and the “blue button” for chat interaction abilities.

### Recording and Transcription Functionality

Pressing the red button initiates the recording process. The device starts recording audio and begins transcribing the spoken content in real time. It uses advanced algorithms to recognize individual speakers based on their voice and assigns their spoken words to them in the transcript.

Speakers can introduce themselves by name, and the device will associate the speaker's voice with their name instead of ex “speaker 1” in the transcription.

The user can also name the recording, allowing the device to store and organize recording data accordingly.

### Playback and AI Interaction

The device can either play back the raw audio or by pressing the blue button, use OpenAI's language model for listening and speaking features. In AI mode, the user can ask questions like “What were the key points discussed in yesterday's meeting?” or “What did Jessica say about the CRM program last week?” The AI system will reference the stored transcriptions to provide detailed responses based on the content of past recordings. The AI can also reference past recordings stored on external sources, such as those accessible through cloud storage.

### Storage and Organization

The device has internal storage as well as SD Card in some models to organize transcriptions by recording name and date. It also features an efficient search function, allowing users to retrieve recording data based on keywords, speakers, dates, or topics. If the model allows for SD card storage, the user can use this to import transcriptions of recordings from other sources, such as online video calls.

In subscription based models, users have the ability to create company and department ID profiles, allowing other users within these departments to access recordings they or their devices may not have attended via cloud storage.

1. A handheld device for recording audio and transcribing speech in real-time, comprising:
a. A recording module for capturing audio.
b. A transcription module for converting audio into text in real time.
c. A speaker identification module for assigning speech to specific speakers based on voice recognition.

2. The device of claim 1, wherein the transcription module generates a text file for each recorded audio.

3. The device of claim 1, further comprising a playback module for interacting with an AI system powered by OpenAI's language models to retrieve recording summaries and specific details based on user queries.

4. The device of claim 3, wherein the playback module allows the user to initiate a conversation with the AI system by pressing a button and asking questions related to the stored recording data.

5. The device of claim 1, wherein the user can name recordings and speakers, and the device will store these names for organizing transcriptions.

6. The device of claim 3, wherein the AI module references past transcriptions to provide responses based on speaker inputs, recording dates, or keywords.
